(19) United States
(12) Patent Application Publication
(10) Pub. No.: US 2026/0035898 A1
(43) Pub. Date: Feb. 5, 2026

(54) AUTOMATIC TOILET CLEANING DEVICE

(71) Applicant: Julius Kelly, Long Beach, CA (US)

(72) Inventor: Julius Kelly, Long Beach, CA (US)

(21) Appl. No.: 18/794,920

(22) Filed: Aug. 5, 2024

(51) Int. Cl. E03D 9/03; B01F 25/312; E03D 9/00; E03D 9/02

(52) U.S. Cl. CPC E03D 9/038; B01F 25/31242; B01F 25/312511; E03D 9/002; E03D 9/032; E03D 2009/028

(57) ABSTRACT

An automatic toilet cleaning device includes a container which contains a fluid cleaning agent and which is suspended in a tank of a toilet. A venturi valve is included which has a fluid input, a fluid output and a mixing input in fluid communication with each of the fluid input and the fluid output. The fluid input receives water from a fluid supply each time the toilet is flushed. The mixing input is in fluid communication with the container to mix the fluid cleaning agent with the water flowing through the venturi valve each time the toilet is flushed. The fluid output dispenses the mixture of the fluid cleaning agent and the water into a bowl of the toilet for cleaning the bowl of the toilet each time the toilet is flushed. The venturi valve includes a throttle for controlling a volume of the fluid cleaning agent.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to toilet cleaning devices and more particularly pertains to a new toilet cleaning device for automatically cleaning a bowl of a toilet each time the toilet is flushed. The device includes a container which is suspended in a tank of the toilet which contains a fluid cleaning agent. The device includes a venturi valve that is in fluid communication with a fluid supply line of the toilet and a bowl supply line of the toilet and the container. The venturi valve mixes the fluid cleaning agent with water that is delivered from the fluid supply line thereby enabling the mixture of the fluid cleaning agent and the water to be delivered to the bowl supply line thereby enabling the mixture of the fluid cleaning agent and the water to clean the bowl each time the toilet is flushed.

### (2) Description of Related Art Including Information Disclosed Under 37 CFR 1.97 and 1.98

The prior art relates to toilet cleaning devices including a variety of automated toilet cleaning devices that each at least includes a fluid reservoir which contains a fluid cleaning agent and a mixing valve in fluid communication between the fluid reservoir and a fluid supply of a toilet and a venturi integrated into the mixing valve for urging the fluid cleaning agent to mix with water that flows through the mixing valve without the use of electronics for cleaning the toilet. In no instance does the prior art disclose an automated toilet cleaning device that includes a fluid reservoir which contains a fluid cleaning agent and a venturi valve in fluid communication between the fluid reservoir and a fluid supply of a toilet for mixing the fluid cleaning agent with the water that flows through the venturi valve and a throttle which is integrated into the venturi valve for throttling the volume of fluid cleaning agent which can mix with the water.

### BRIEF SUMMARY OF THE INVENTION

An embodiment of the disclosure meets the needs presented above by generally comprising a container which contains a fluid cleaning agent and which is suspended in a tank of a toilet. A venturi valve is included which has a fluid input, a fluid output and a mixing input in fluid communication with each of the fluid input and the fluid output. The fluid input receives water from a fluid supply each time the toilet is flushed. The mixing input is in fluid communication with the container to mix the fluid cleaning agent with the water flowing through the venturi valve each time the toilet is flushed. The fluid output dispenses the mixture of the fluid cleaning agent and the water into a bowl of the toilet for cleaning the bowl of the toilet each time the toilet is flushed. The venturi valve includes a throttle for controlling a volume of the fluid cleaning agent.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an automatic toilet cleaning device according to an embodiment of the disclosure.

FIG. 2 is a perspective view of a venturi valve of an embodiment of the disclosure.

FIG. 3 is a cross sectional view taken along line 3-3 of FIG. 2 of an embodiment of the disclosure.

FIG. 4 is a front cut-away view of a tank of a toilet of an embodiment of the disclosures.

FIG. 5 is a cross sectional view taken along line 5-5 of FIG. 4 of an embodiment of the disclosure.

FIG. 6 is a front cut-away view of a venturi valve and a fluid supply line and a bowl supply line and a mixing line of an embodiment of the disclosure.

### DETAILED DESCRIPTION OF THE INVENTION

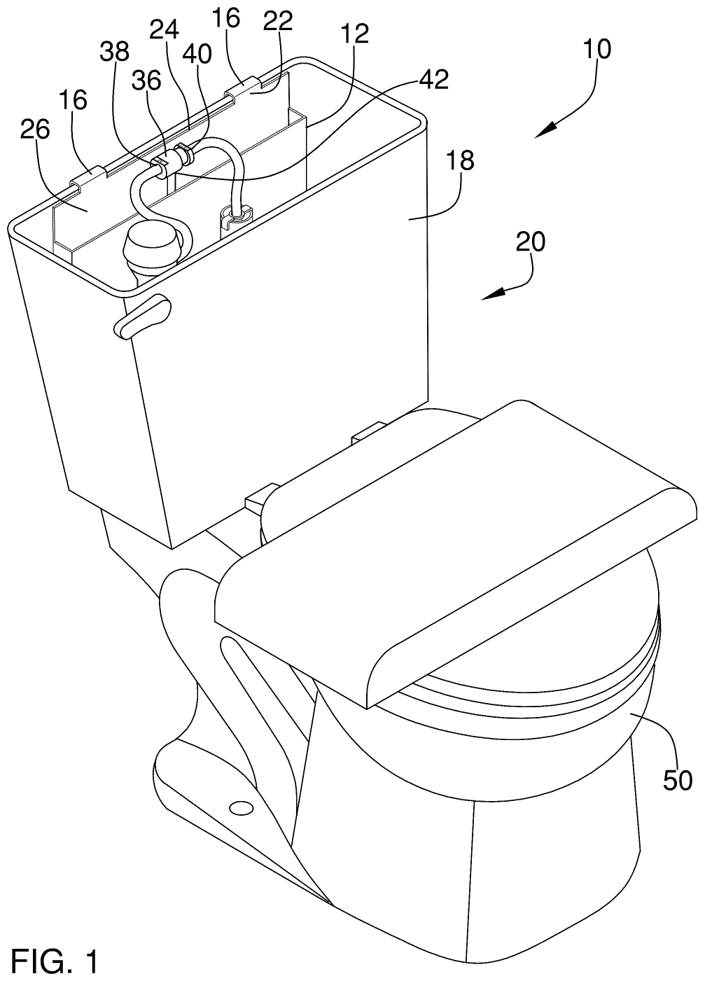

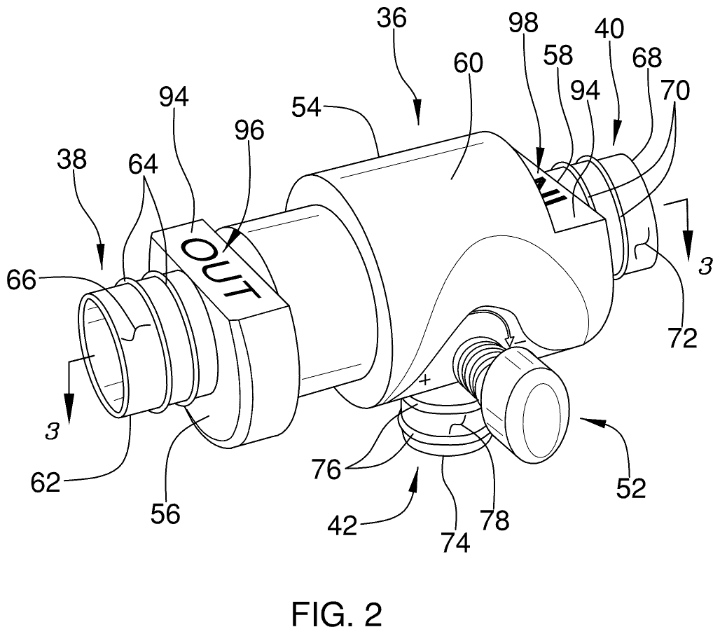

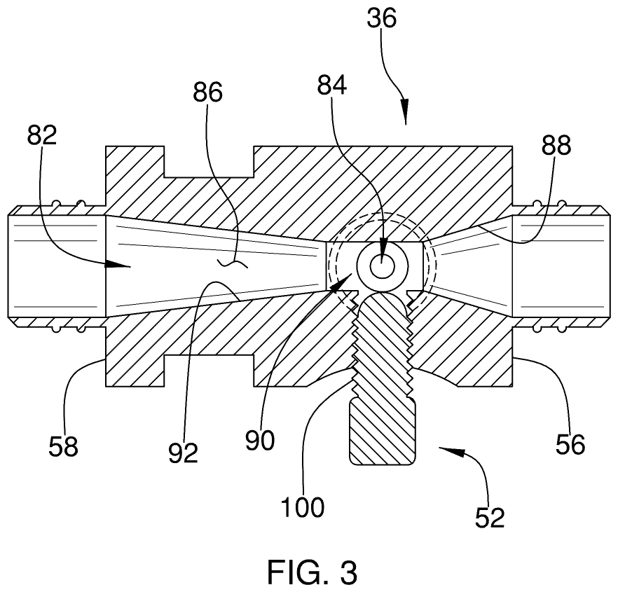

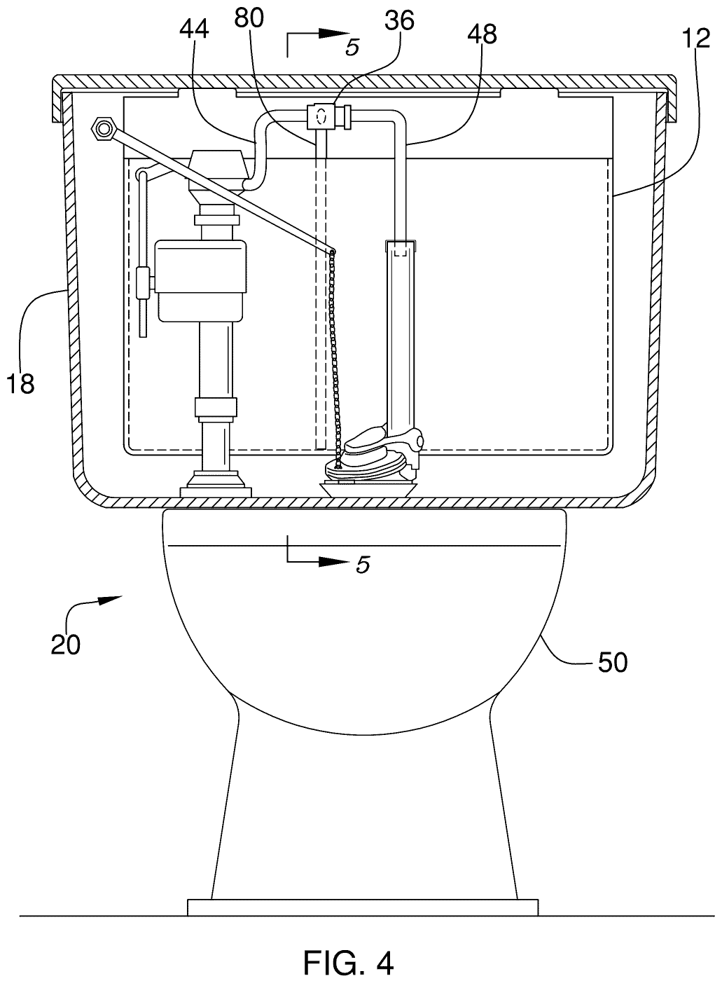

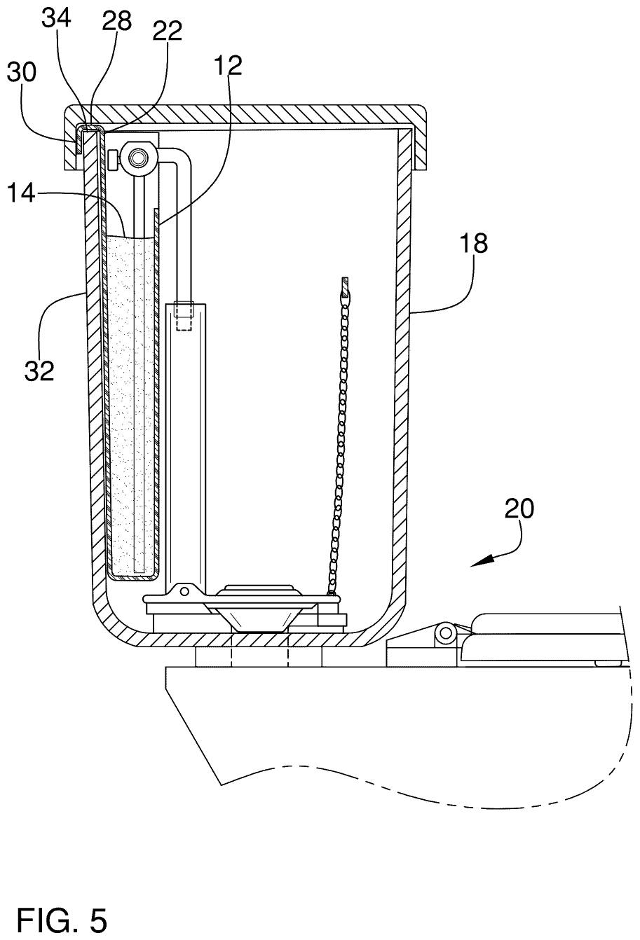

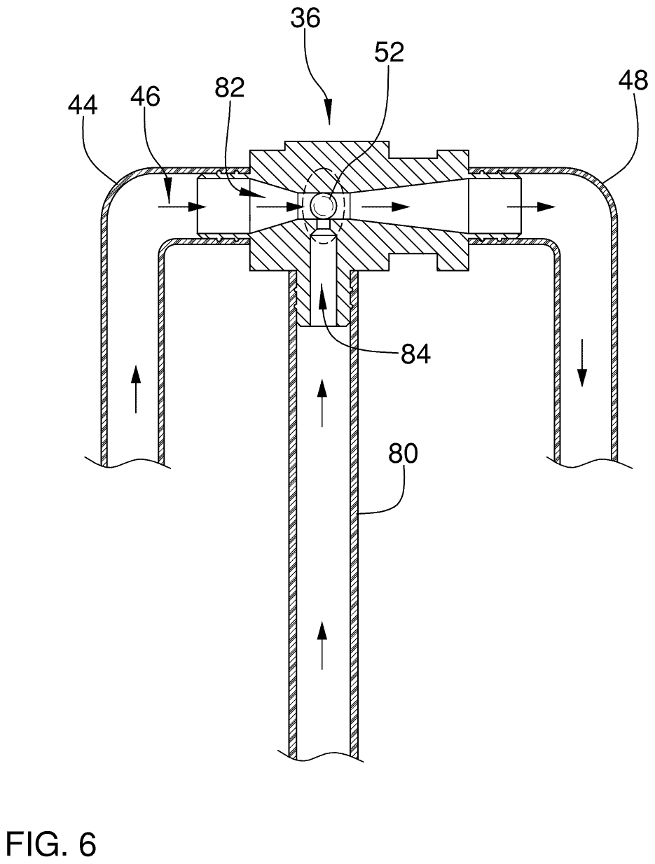

With reference now to the drawings, and in particular to FIGS. 1 through 6 thereof, a new toilet cleaning device embodying the principles and concepts of an embodiment of the disclosure and generally designated by the reference numeral 10 will be described.

As best illustrated in FIGS. 1 through 6, the automatic toilet cleaning device 10 generally comprises a container 12 which is comprised of a fluid impermeable material thereby enabling the container 12 to contain a fluid cleaning agent 14. The fluid cleaning agent 14 may comprise an organic compound that is non-toxic for human consumption and which is capable of dissolving minerals which are in solution in water. The container 12 has a grapple 16 which is integrated into the container 12 thereby enabling the grapple 16 to grip a tank 18 of a toilet 20 thereby enabling the container 12 to be suspended in the tank 18. The grapple 16 has a front panel 22 which extends upwardly from a top edge 24 of the container 12 which corresponds to a rear wall 26 of the container 12. The grapple 16 has a top panel 28 which is perpendicularly oriented with the front panel 22 and a rear panel 30 extending downwardly from and being perpendicularly oriented with the top panel 28. The rear panel 30 is spaced from the front panel 22 to enable an outer wall 32 of the tank 18 to be positioned between the front panel 22 and the rear panel 30 having the top panel 28 resting on an upper edge 34 of the outer wall 32 of the tank 18. Additionally, the toilet 20 may be a toilet of any conventional design that is commonly employed in residential plumbing.

A venturi valve 36 is provided which has a fluid input 38 and a fluid output 40 and a mixing input 42 that is in fluid communication with each of the fluid input 38 and the fluid output 40. The fluid input 38 is in fluid communication with a fluid supply line 44 of the toilet 20 thereby enabling the fluid input 38 to receive water 46 from the fluid supply line 44 each time the toilet 20 is flushed. The mixing input 42 is in fluid communication with the container 12 thereby enabling the venturi valve 36 to receive the fluid cleaning agent 14 in the container 12. The venturi valve 36 mixes the fluid cleaning agent 14 with the water 46 flowing through the venturi valve 36 each time the toilet 20 is flushed.

The fluid output 40 is in fluid communication with a bowl supply line 48 of the toilet 20 to enable the venturi valve 36 to dispense the mixture of the fluid cleaning agent 14 and the water 46 into the bowl supply line 48. In this way the mixture of the fluid cleaning agent 14 and the water 46 can be released into a bowl 50 of the toilet 20 for cleaning the bowl 50 of the toilet 20 each time the toilet 20 is flushed. Furthermore, the fluid cleaning agent 14 can inhibit the formation of mineral deposits in the bowl 50 of the toilet 20 thereby enhancing cleanliness of the bowl 50 over time.

The venturi valve 36 has a throttle 52 which is movably integrated into the venturi valve 36. The throttle 52 is in communication with the mixing input 42 for controlling an amount of the fluid cleaning agent 14 which flows into the venturi valve 36 between a minimum amount and a maximum amount. The venturi valve 36 has a cylindrical body 54 which has a first end 56 and a second end 58 and an exterior wall 60 extending between the first end 56 and the second end 58; each of the first end 56 and the second end 58 is open.

The venturi valve 36 has a first nipple 62 which is attached to the first end 56 such that the first nipple 62 defines the fluid input 38. The first nipple 62 has a series of ribs 64 on an outer surface 66 of the first nipple 62 thereby enabling the fluid supply line 44 of the toilet 20 to engage the series of ribs 64 when the first nipple 62 is inserted into the fluid supply line 44 to inhibit the fluid supply line 44 from becoming dislodged from the first nipple 62. The venturi valve 36 has a second nipple 68 which is attached to the second end 58 such that the second nipple 68 defines the fluid output 40. The second nipple 68 has a series of ribs 70 on an outer surface 72 of the second nipple 68 thereby enabling the bowl supply line 48 to engage the series of the ribs 70 on the outer surface 72 of the second nipple 68 when the second nipple 68 is inserted into the bowl supply line 48 to inhibit the bowl supply line 48 from becoming dislodged from the second nipple 68.

The venturi valve 36 has a third nipple 74 which is attached to the exterior wall 60 of the venturi valve 36 such that the third nipple 74 defines the mixing input 42. The third nipple 74 has a series of ribs 76 on an outer surface 78 of the third nipple 74 thereby enabling a mixing line 80 to engage the series of ribs 76 on the outer surface 78 of the third nipple 74 when the third nipple 74 is inserted into the mixing line 80 to inhibit the mixing line 80 from becoming dislodged from the third nipple 74. Additionally, the mixing line 80 extends into the container 12 thereby enabling the third nipple 74 to receive the fluid cleaning agent 14 from the container 12.

The cylindrical body 54 has a fluid channel 82 which extends between the first end 56 and the second end 58 such that the fluid channel 82 is in fluid communication with each of the first nipple 62 and the second nipple 68. In this way the fluid channel 82 enables the water 46 from the fluid supply line 44 to flow through the fluid channel 82. The cylindrical body 54 has a mixing channel 84 which extends through the exterior wall 60 and intersects the fluid channel 82. The mixing channel 84 is in fluid communication with the third nipple 74 thereby enabling the mixing channel 84 to receive the fluid cleaning agent 14 from the mixing line 80.

The fluid channel 82 has a bounding surface 86 and the bounding surface 86 of the fluid channel 82 has a first portion 88 which tapers in diameter between the first end 56 and an intersection 90 with the mixing channel 84. In this way the first portion 88 increases a fluid pressure of the water 46 which flows between the first nipple 62 and the intersection 90 of the mixing channel 84. The bounding surface 86 of the fluid channel 82 has a second portion 92 which tapers in diameter between the second end 58 and the intersection 90 with the mixing channel 84. In this way the second portion 92 decreases the fluid pressure of the water 46 which flows between the intersection 90 of the mixing channel 84 and the second nipple 68 thereby creating a vacuum at the intersection 90 of the mixing channel 84 via the venturi effect. In this way the fluid cleaning agent 14 in the container 12 can be drawn into the fluid channel 82 when the water 46 flows through the fluid channel 82. Additionally, the intersection 90 with the mixing channel 84 is positioned closer to the first end 56 than the second end 58.

The exterior wall 60 of the venturi valve 36 has a pair of planar portions 94 each located adjacent to a respective one of the first end 56 and the second end 58 of the venturi valve 36. The exterior wall 60 has indicia 96 which are applied to the planar portion 94 positioned adjacent to the first end 56 comprising the word “In”. Additionally, the exterior wall 60 has indicia 98 which are applied to the planar portion 94 positioned adjacent to the second end 58 comprising the word “Out”. The throttle 52 comprises a screw 100 which extends through the exterior wall 60 of the venturi valve 36 and into the intersection 90 between the mixing channel 84 and the fluid channel 82. The screw 100 travels into the intersection 90 and subsequently decreases a diameter of the intersection 90 when the screw 100 is tightened thereby decreasing the volume of the fluid cleaning agent 14 that can flow through the intersection 90. Conversely, the screw 100 travels out of the intersection 90 and subsequently increases a diameter of the intersection 90 when the screw 100 is loosened thereby increasing the volume of the fluid cleaning agent 14 that can flow through the intersection 90.

In use, the grapple 16 of the container 12 is positioned on the outer wall of the tank 18 of the toilet 20 to suspend the container 12 within the tank 18. The fluid supply line 44 is coupled to the first nipple 62 and the bowl supply line 48 is coupled to the second nipple 68 and the mixing line 80 is coupled to the third nipple 74. Additionally, the screw 100 is tightened or loosened to establish the volume of fluid cleaning agent 14 that can flow through the venturi valve 36. The fluid cleaning agent 14 is drawn into the venturi valve 36 each time the toilet 20 is flushed which results in the water 46 flowing through the venturi valve 36. In this way the fluid cleaning agent 14 is mixed with the water 46 that flows through the venturi valve 36 thereby delivering the mixture of the fluid cleaning agent 14 and the water 46 into the bowl 50. Thus, the mixture of the fluid cleaning agent 14 and the water 46 inhibits the formation of mineral deposits in the bowl 50 of the toilet 20 and enhances the overall cleanliness and appearance of the toilet 20 bowl 50.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An automatic toilet cleaning device for automatically releasing a chemical cleaning agent into water employed to fill a toilet bowl each time a toilet is flushed, said device comprising:
a container being comprised of a fluid impermeable material thereby enabling said container to contain a fluid cleaning agent, said container having a grapple being integrated into said container thereby enabling said grapple to grip a tank of a toilet thereby enabling said container to be suspended in said tank; and
a venturi valve having a fluid input and a fluid output and a mixing input being in fluid communication with each of said fluid input and said fluid output, said fluid input being in fluid communication with a fluid supply line of said toilet wherein said fluid input is configured to receive water from said fluid supply each time said toilet is flushed, said mixing input being in fluid communication with said container thereby enabling said venturi valve to receive said fluid cleaning agent in said container wherein said venturi valve is configured to mix said fluid cleaning agent with the water flowing through said venturi valve each time said toilet is flushed, said fluid output being in fluid communication with a bowl supply line of said toilet wherein said venturi valve is configured to dispense the mixture of said fluid cleaning agent and the water into said bowl supply line thereby enabling the mixture of said fluid cleaning agent and the water to be released into a bowl of said toilet for cleaning said bowl of said toilet each time said toilet is flushed, said venturi valve having a throttle being movably integrated into said venturi valve, said throttle being in communication with said mixing input for controlling an amount of said fluid cleaning agent which flows into said venturi valve between a minimum amount and a maximum amount.

2. The device according to claim 1, wherein:
grapple has a front panel which extends upwardly from a top edge of said container which corresponds to a rear wall of said container; and
said grapple has a top panel being perpendicularly oriented with said front panel and a rear panel extending downwardly from and being perpendicularly oriented with said top panel having said rear panel being spaced from said front panel to enable an outer wall of said tank to be positioned between said front panel and said rear panel having said top panel resting on an upper edge of said outer wall of said tank.

3. The device according to claim 1, wherein:
said venturi valve has a cylindrical body which has a first end and a second end and an exterior wall extending between said first end and said second end;
each of said first end and said second end is open;
said venturi valve has a first nipple being attached to said first end such that said first nipple defines said fluid input;
said first nipple has a series of ribs on an outer surface of said first nipple thereby enabling fluid supply line of said toilet to engage said series of ribs when said first nipple is inserted into said fluid supply line to inhibit said fluid supply line from becoming dislodged from said first nipple;
said venturi valve has a second nipple being attached to said second end such that said second nipple defines said fluid output;
said second nipple has a series of ribs on an outer surface of said second nipple thereby enabling said bowl supply line to engage said series of said ribs on said outer surface of said second nipple when said second nipple is inserted into said bowl supply line to inhibit said bowl supply line from becoming dislodged from said second nipple;
said venturi valve has a third nipple being attached to said exterior wall of said venturi valve such that said third nipple defines said mixing input;
said third nipple has a series of ribs on an outer surface of said third nipple thereby enabling a mixing line to engage said series of ribs on said outer surface of said third nipple when said third nipple is inserted into said mixing line to inhibit said mixing line from becoming dislodged from said third nipple; and
said mixing line extends into said container thereby enabling said third nipple to receive said fluid cleaning agent from said container.

3. The device according to claim 2, wherein:
said cylindrical body has a fluid channel which extends between said first end and said second end such that said fluid channel is in fluid communication with each of said first nipple and said second nipple wherein said fluid channel is configured to enable the water from said fluid supply line to flow through said fluid channel;
said cylindrical body has a mixing channel which extends through said exterior wall and intersects said fluid channel; and
said mixing channel is in fluid communication with said third nipple thereby enabling said mixing channel to receive said fluid cleaning agent from said mixing line.

4. The device according to claim 3, wherein:
said fluid channel has a bounding surface;
said bounding surface of said fluid channel has a first portion which tapers in diameter between said first end and an intersection with said mixing channel wherein said first portion is configured to increase a fluid pressure of the water which flows between said first nipple and said intersection of said mixing channel;
said bounding surface of said fluid channel has a second portion which tapers in diameter between said second end and said intersection with said mixing channel wherein said second portion is configured to decrease the fluid pressure of the water which flows between said intersection of said mixing channel and said second nipple thereby creating a vacuum at said intersection of said mixing channel thereby enabling said fluid cleaning agent in said container to be drawn into said fluid channel when the water flows through said fluid channel; and
said intersection with said mixing channel is positioned closer to said first end than said second end.

5. The device according to claim 1, wherein:
said venturi valve has a cylindrical body which has a first end and a second end and an exterior wall extending between said first end and said second end;
said exterior wall of said venturi valve has a pair of planar portions each being located adjacent to a respective one of said first end and said second end of said venturi valve;
said exterior wall has indicia being applied to said planar portion positioned adjacent to said first end comprising the word “In”; and
said exterior wall has indicia being applied to said planar portion positioned adjacent to said second end comprising the word “Out”.

6. The device according to claim 3, wherein:
said throttle comprises a screw which extends through said exterior wall of said venturi valve and into said intersection between said mixing channel and said fluid channel;
said screw decreases a diameter of said intersection when said screw is tightened thereby decreasing the volume of said fluid cleaning agent that can flow through said intersection; and
said screw increases a diameter of said intersection when said screw is loosened thereby increasing said volume of said fluid cleaning agent that can flow through said intersection.

7. An automatic toilet cleaning device for automatically releasing a chemical cleaning agent into water employed to fill a toilet bowl each time a toilet is flushed, said device comprising:
a container being comprised of a fluid impermeable material thereby enabling said container to contain a fluid cleaning agent, said container having a grapple being integrated into said container thereby enabling said grapple to grip a tank of a toilet thereby enabling said container to be suspended in said tank, said grapple having a front panel which extends upwardly from a top edge of said container which corresponds to a rear wall of said container, said grapple having a top panel being perpendicularly oriented with said front panel and a rear panel extending downwardly from and being perpendicularly oriented with said top panel having said rear panel being spaced from said front panel to enable an outer wall of said tank to be positioned between said front panel and said rear panel having said top panel resting on an upper edge of said outer wall of said tank; and
a venturi valve having a fluid input and a fluid output and a mixing input being in fluid communication with each of said fluid input and said fluid output, said fluid input being in fluid communication with a fluid supply line of said toilet wherein said fluid input is configured to receive water from said fluid supply each time said toilet is flushed, said mixing input being in fluid communication with said container thereby enabling said venturi valve to receive said fluid cleaning agent in said container wherein said venturi valve is configured to mix said fluid cleaning agent with the water flowing through said venturi valve each time said toilet is flushed, said fluid output being in fluid communication with a bowl supply line of said toilet wherein said venturi valve is configured to dispense the mixture of said fluid cleaning agent and the water into said bowl supply line thereby enabling the mixture of said fluid cleaning agent and the water to be released into a bowl of said toilet for cleaning said bowl of said toilet each time said toilet is flushed, said venturi valve having a throttle being movably integrated into said venturi valve, said throttle being in communication with said mixing input for controlling an amount of said fluid cleaning agent which flows into said venturi valve between a minimum amount and a maximum amount, said venturi valve having a cylindrical body having a first end and a second end and an exterior wall extending between said first end and said second end, each of said first end and said second end being open, said venturi valve having a first nipple being attached to said first end such that said first nipple defines said fluid input, said first nipple having a series of ribs on an outer surface of said first nipple thereby enabling fluid supply line of said toilet to engage said series of ribs when said first nipple is inserted into said fluid supply line to inhibit said fluid supply line from becoming dislodged from said first nipple, said venturi valve having a second nipple being attached to said second end such that said second nipple defines said fluid output, said second nipple having a series of ribs on an outer surface of said second nipple thereby enabling said bowl supply line to engage said series of said ribs on said outer surface of said second nipple when said second nipple is inserted into said bowl supply line to inhibit said bowl supply line from becoming dislodged from said second nipple, said venturi valve having a third nipple being attached to said exterior wall of said venturi valve such that said third nipple defines said mixing input, said third nipple having a series of ribs on an outer surface of said third nipple thereby enabling a mixing line to engage said series of ribs on said outer surface of said third nipple when said third nipple is inserted into said mixing line to inhibit said mixing line from becoming dislodged from said third nipple, said mixing line extending into said container thereby enabling said third nipple to receive said fluid cleaning agent from said container, said cylindrical body having a fluid channel which extends between said first end and said second end such that said fluid channel is in fluid communication with each of said first nipple and said second nipple wherein said fluid channel is configured to enable the water from said fluid supply line to flow through said fluid channel, said cylindrical body having a mixing channel which extends through said exterior wall and intersects said fluid channel, said mixing channel being in fluid communication with said third nipple thereby enabling said mixing channel to receive said fluid cleaning agent from said mixing line, said fluid channel having a bounding surface, said bounding surface of said fluid channel having a first portion which tapers in diameter between said first end and an intersection with said mixing channel wherein said first portion is configured to increase a fluid pressure of the water which flows between said first nipple and said intersection of said mixing channel, said bounding surface of said fluid channel having a second portion which tapers in diameter between said second end and said intersection with said mixing channel wherein said second portion is configured to decrease the fluid pressure of the water which flows between said intersection of said mixing channel and said second nipple thereby creating a vacuum at said intersection of said mixing channel thereby enabling said fluid cleaning agent in said container to be drawn into said fluid channel when the water flows through said fluid channel, said intersection with said mixing channel being positioned closer to said first end than said second end, said exterior wall of said venturi valve having a pair of planar portions each being located adjacent to a respective one of said first end and said second end of said venturi valve, said exterior wall having indicia being applied to said planar portion positioned adjacent to said first end comprising the word “In”, said exterior wall having indicia being applied to said planar portion positioned adjacent to said second end comprising the word “Out”, said throttle comprising a screw which extends through said exterior wall of said venturi valve and into said intersection between said mixing channel and said fluid channel, said screw decreasing a diameter of said intersection when said screw is tightened thereby decreasing the volume of said fluid cleaning agent that can flow through said intersection, said screw increasing a diameter of said intersection when said screw is loosened thereby increasing said volume of said fluid cleaning agent that can flow through said intersection.
